(19) United States
(12) Patent Application Publication
(10) Pub. No.: US 2009/0005076 A1
(43) Pub. Date: Jan. 1, 2009

(54) Location-Based Information Services

(76) Inventors: Scott Forstall, Mountain View, CA (US); Gregory N. Christie, San Jose, CA (US); Robert E. Borchers, Pleasanton, CA (US); Imran A. Chaudhri, San Francisco, CA (US)

Correspondence Address: FISH & RICHARDSON P.C., PO BOX 1022, MINNEAPOLIS, MN, 55440-1022, US

(21) Appl. No.: 11/966,863

(22) Filed: Dec. 28, 2007

Related U.S. Application Data
(60) Provisional application No. 60/946,927, filed on Jun. 28, 2007.

(51) Int. Cl. H04Q 7/20; G06F 3/041

(52) U.S. Cl. 455/456.2; 345/173

(57) ABSTRACT

Methods, systems, and computer-readable medium for providing location-based information services. In one implementation, a method is provided. The method includes receiving first information associated with a user of a mobile device. Second information identifying a first geographic location of the mobile device is received. Location-based content is filtered using the first information and the second information. The filtered location-based content is provided to the user at the mobile device, where the mobile device includes a multi-touch sensitive display.

### CROSS-REFERENCE TO RELATED APPLICATIONS

This application claims priority to U.S. Provisional Patent Application Ser. No. 60/946,927 filed Jun. 28, 2007, and entitled “Location-Based Information Services,” the contents of which are incorporated herein by reference.

### TECHNICAL FIELD

The subject matter of this patent application is generally related to mobile devices.

### BACKGROUND

A user of a mobile device who is traveling from one geographic location to another might desire location-based information services, whether the user is in the user's “home” location or the user is away from the home location. For example, a user of a mobile device, while traveling for business or leisure, might want to receive local information, such as the type of information available in some travel guides. Some examples of location-based information include weather reports, restaurant reviews, and cultural or sports venue schedules. A user wishing to gain this information can search the Internet, visit the local tourism office, or consult a travel guide or a local newspaper. However, these approaches require the user to actively search a resource, can be time-consuming, can provide outdated information, and can produce a large amount of information that may be of little interest to the user.

### SUMMARY

Methods, systems, and computer-readable medium for providing location-based information services are provided. In general, in one aspect, a method is provided. The method includes receiving first information associated with a user of a mobile device. Second information identifying a first geographic location of the mobile device is received. Location-based content is filtered using the first information and the second information. The filtered location-based content is provided to the user at the mobile device, where the mobile device includes a multi-touch sensitive display.

Implementations can include one or more of the following features. Third information identifying a second geographic location of the mobile device can be received, and updated filtered location-based content can be provided to the user, where the updated filtered location-based content is location-based content filtered using the third information. Third information provided by the user of the mobile device can be received, and the third information can be added to the location-based content. The first information associated with the user can identify a selection of one or more types of location-based content. Receiving the first information can include presenting a graphical user interface requesting information and receiving input responsive to the request. The selection of one or more types of location-based content can be location-based. The second information identifying the first geographic location of the mobile device can be provided by the mobile device. The location-based content can be filtered by the mobile device. The mobile device can include a telephony application. Filtering location-based content can include filtering location-based content using information from at least one user profile or filtering location-based content based on time.

In one aspect, a method is provided. The method includes receiving first information associated with a user of a mobile device. Second information identifying a first geographic location of the mobile device is received. Third information associated with a user profile of a different user is received. Location-based content is filtered using the first information, the second information, and the third information. The filtered location-based content is provided to the user at the mobile device.

In one aspect, a method is provided. The method includes receiving first information associated with a user of a mobile device. Second information identifying a first geographic location of the mobile device is received. Location-based content is filtered using the first information and the second information, where the location-based content is filtered at the mobile device. The filtered location-based content is provided to the user at the mobile device.

Other implementations are disclosed, including implementations directed to systems and computer-readable medium.

Particular embodiments of the subject matter described in this specification can be implemented to realize one or more of the following advantages. Location-based information services can be provided to a user through a mobile device by automatically pushing or pulling the services from a network resource. The information services can be filtered based on user preferences and a geographic location of the mobile device. Additionally, the user can provide location-based information to a network-based repository and/or service, where the user-provided information can be used to enrich information provided to other users.

### DESCRIPTION OF DRAWINGS

FIG. 1 is a block diagram of an example mobile device.

FIG. 2 is a block diagram of an example network operating environment for the mobile device of FIG. 1.

FIG. 3 is a block diagram of an example implementation of the mobile device of FIG. 1.

FIG. 4A illustrates an example implementation of a software stack for the mobile device of FIG. 1

FIG. 4B illustrates an example implementation of a security process for remote access management over a secure communications channel.

FIG. 5 is a block diagram of an example implementation of the information service block of FIG. 2.

FIG. 6A illustrates an example of setting preferences for location-based information services for the mobile device of FIG. 1.

FIG. 6B illustrates an example of using the mobile device of FIG. 1 to receive and display location-based information services.

FIG. 7 is a flow diagram of an example process 700 for providing location-based information services for the mobile device of FIG. 1.

### DETAILED DESCRIPTION

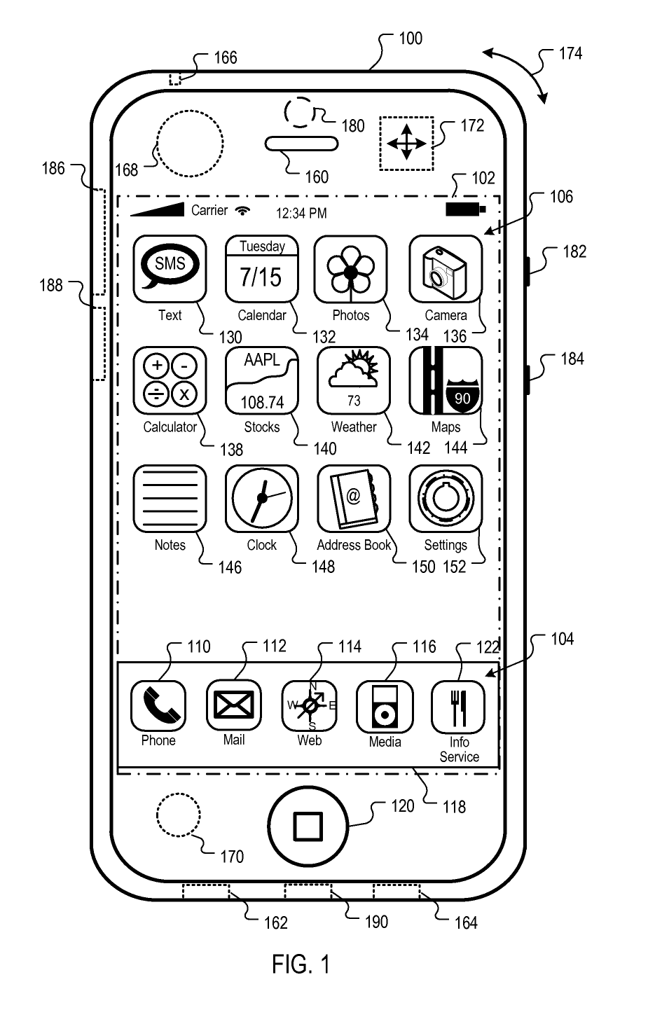

FIG. 1 is a block diagram of an example mobile device 100. The mobile device 100 can be, for example, a handheld computer, a personal digital assistant, a cellular telephone, a network appliance, a camera, a smart phone, an enhanced general packet radio service (EGPRS) mobile phone, a network base station, a media player, a navigation device, an email device, a game console, or other electronic device or a combination of any two or more devices.

### Mobile Device Overview

In some implementations, the mobile device 100 includes a touch-sensitive display 102. The touch-sensitive display 102 can implement liquid crystal display (LCD) technology, light emitting polymer display (LPD) technology, or some other display technology. The touch-sensitive display 102 can be sensitive to haptic and/or tactile contact with a user.

In some implementations, the touch-sensitive display 102 can comprise a multi-touch-sensitive display 102. A multi-touch-sensitive display 102 can, for example, process multiple simultaneous touch points, including processing data related to the pressure, degree, and/or position of each touch point. Such processing facilitates gestures and interactions with multiple fingers, chording, and other interactions. Other touch-sensitive display technologies can also be used, e.g., a display in which contact is made using a stylus or other pointing device. Some examples of multi-touch-sensitive display technology are described in U.S. Pat. Nos. 6,323,846, 6,570,557, 6,677,932, and U.S. Patent Publication 2002/0015024A1, each of which is incorporated by reference herein in its entirety.

In some implementations, the mobile device 100 can display one or more graphical user interfaces on the touch-sensitive display 102 for providing the user access to various system objects and for conveying information to the user. In some implementations, the graphical user interface can include one or more display objects 104, 106. In the example shown, the display objects 104, 106, are graphic representations of system objects. Some examples of system objects include device functions, applications, windows, files, alerts, events, or other identifiable system objects.

### Example Mobile Device Functionality

In some implementations, the mobile device 100 can implement multiple device functionalities, such as a telephony device, as indicated by a phone object 110; an e-mail device, as indicated by the e-mail object 112; a network data communication device, as indicated by the Web object 114; a Wi-Fi base station device (not shown); a media processing device, as indicated by the media player object 116, and a location-based services device, as indicated by the information services object 122. In some implementations, particular display objects 104, e.g., the phone object 110, the e-mail object 112, the Web object 114, the media player object 116, and the information services object 122, can be displayed in a menu bar 118. In some implementations, device functionalities can be accessed from a top-level graphical user interface, such as the graphical user interface illustrated in FIG. 1. Touching one of the objects 110, 112, 114, 116, or 122 can, for example, invoke corresponding functionality.

In some implementations, the mobile device 100 can implement network distribution functionality. For example, the functionality can enable the user to take the mobile device 100 and its associated network while traveling. In particular, the mobile device 100 can extend Internet access (e.g., Wi-Fi) to other wireless devices in the vicinity. For example, mobile device 100 can be configured as a base station for one or more devices. As such, mobile device 100 can grant or deny network access to other wireless devices.

In some implementations, upon invocation of device functionality, the graphical user interface of the mobile device 100 changes, or is augmented or replaced with another user interface or user interface elements, to facilitate user access to particular functions associated with the corresponding device functionality. For example, in response to a user touching the phone object 110, the graphical user interface of the touch-sensitive display 102 may present display objects related to various phone functions; likewise, touching of the email object 112 may cause the graphical user interface to present display objects related to various e-mail functions; touching the Web object 114 may cause the graphical user interface to present display objects related to various Web-surfing functions; touching the media player object 116 may cause the graphical user interface to present display objects related to various media processing functions; and touching the information services object 122 may cause the graphical user interface to present display objects related to various location-based services.

In some implementations, the top-level graphical user interface environment or state of FIG. 1 can be restored by pressing a button 120 located near the bottom of the mobile device 100. In some implementations, each corresponding device functionality may have corresponding “home” display objects displayed on the touch-sensitive display 102, and the graphical user interface environment of FIG. 1 can be restored by pressing the “home” display object.

In some implementations, the top-level graphical user interface can include additional display objects 106, such as a short messaging service (SMS) object 130, a calendar object 132, a photos object 134, a camera object 136, a calculator object 138, a stocks object 140, a weather object 142, a maps object 144, a notes object 146, a clock object 148, an address book object 150, and a settings object 152. Touching the SMS display object 130 can, for example, invoke an SMS messaging environment and supporting functionality; likewise, each selection of a display object 132, 134, 136, 138, 140, 142, 144, 146, 148, 150, and 152 can invoke a corresponding object environment and functionality.

Additional and/or different display objects can also be displayed in the graphical user interface of FIG. 1. For example, if the device 100 is functioning as a base station for other devices, one or more “connection” objects may appear in the graphical user interface to indicate the connection. In some implementations, the display objects 106 can be configured by a user, e.g., a user may specify which display objects 106 are displayed, and/or may download additional applications or other software that provides other functionalities and corresponding display objects.

In some implementations, the mobile device 100 can include one or more input/output (I/O) devices and/or sensor devices. For example, a speaker 160 and a microphone 162 can be included to facilitate voice-enabled functionalities, such as phone and voice mail functions. In some implementations, a loud speaker 164 can be included to facilitate hands-free voice functionalities, such as speakerphone functions. An audio jack 166 can also be included for use of headphones and/or a microphone.

In some implementations, a proximity sensor 168 can be included to facilitate the detection of the user positioning the mobile device 100 proximate to the user's ear and, in response, to disengage the touch-sensitive display 102 to prevent accidental function invocations. In some implementations, the touch-sensitive display 102 can be turned off to conserve additional power when the mobile device 100 is proximate to the user's ear.

Other sensors can also be used. For example, in some implementations, an ambient light sensor 170 can be utilized to facilitate adjusting the brightness of the touch-sensitive display 102. In some implementations, an accelerometer 172 can be utilized to detect movement of the mobile device 100, as indicated by the directional arrow 174. Accordingly, display objects and/or media can be presented according to a detected orientation, e.g., portrait or landscape. In some implementations, the mobile device 100 may include circuitry and sensors for supporting a location determining capability, such as that provided by the global positioning system (GPS) or other positioning systems (e.g., systems using Wi-Fi access points, television signals, cellular grids, Uniform Resource Locators (URLs)). In some implementations, a positioning system (e.g., a GPS receiver) can be integrated into the mobile device 100 or provided as a separate device that can be coupled to the mobile device 100 through an interface (e.g., port device 190) to provide access to location-based services.

The mobile device 100 can also include a camera lens and sensor 180. In some implementations, the camera lens and sensor 180 can be located on the back surface of the mobile device 100. The camera can capture still images and/or video.

The mobile device 100 can also include one or more wireless communication subsystems, such as an 802.11b/g communication device 186, and/or a Bluetooth™ communication device 188. Other communication protocols can also be supported, including other 802.x communication protocols (e.g., WiMax, Wi-Fi, 3G), code division multiple access (CDMA), global system for mobile communications (GSM), Enhanced Data GSM Environment (EDGE), etc.

In some implementations, a port device 190, e.g., a Universal Serial Bus (USB) port, or a docking port, or some other wired port connection, can be included. The port device 190 can, for example, be utilized to establish a wired connection to other computing devices, such as other communication devices 100, network access devices, a personal computer, a printer, or other processing devices capable of receiving and/or transmitting data. In some implementations, the port device 190 allows the mobile device 100 to synchronize with a host device using one or more protocols, such as, for example, the TCP/IP, HTTP, UDP and any other known protocol. In some implementations, a TCP/IP over USB protocol can be used, as described in U.S. Provisional Patent Application No. 60/945,904, filed Jun. 22, 2007, for “Multiplexed Data Stream Protocol,” Attorney Docket No. 004860.P5490, which provisional patent application is incorporated by reference herein in its entirety.

### Network Operating Environment

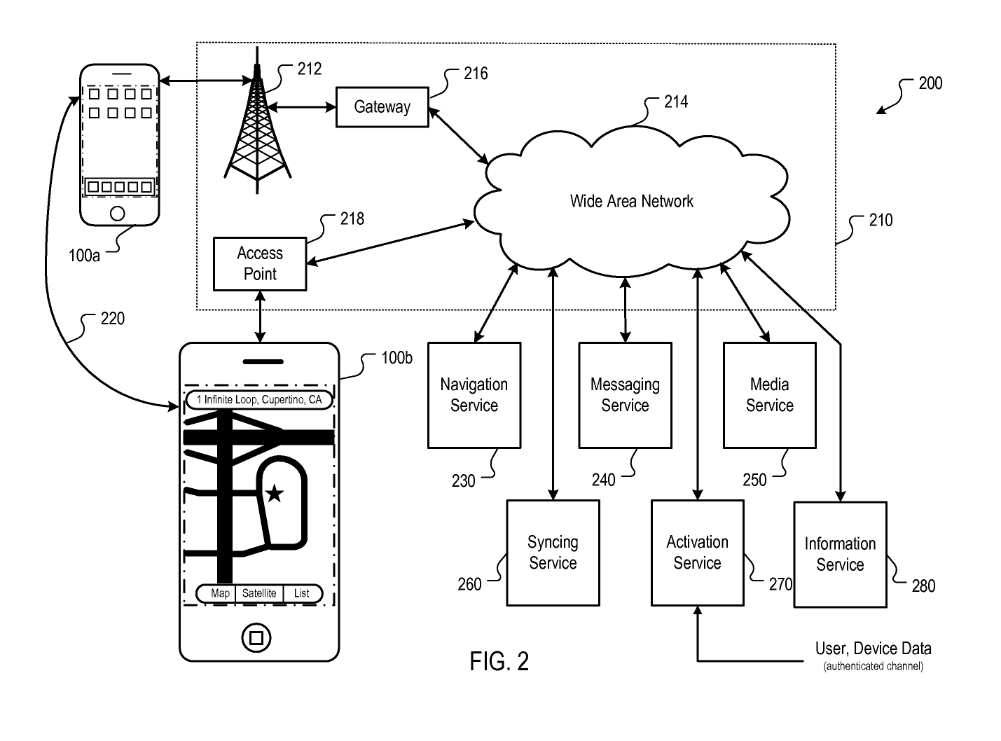

FIG. 2 is a block diagram of an example network operating environment 200 for the mobile device 100 of FIG. 1. The mobile device 100 of FIG. 1 can, for example, communicate over one or more wired and/or wireless networks 210 in data communication. For example, a wireless network 212, e.g., a cellular network, can communicate with a wide area network (WAN) 214, such as the Internet, by use of a gateway 216. Likewise, an access device 218, such as an 802.11g wireless access device, can provide communication access to the wide area network 214. In some implementations, both voice and data communications can be established over the wireless network 212 and the access device 218. For example, the mobile device 100a can place and receive phone calls (e.g., using VoIP protocols), send and receive e-mail messages (e.g., using POP3 protocol), transmit location-based information, receive location-based services, and retrieve electronic documents and/or streams, such as web pages, photographs, and videos, over the wireless network 212, gateway 216, and wide area network 214 (e.g., using TCP/IP or UDP protocols). Likewise, the mobile device 100b can place and receive phone calls, send and receive e-mail messages, transmit location-based information, receive location-based services, and retrieve electronic documents over the access device 218 and the wide area network 214. In some implementations, the mobile device 100 can be physically connected to the access device 218 using one or more cables and the access device 218 can be a personal computer. In this configuration, the mobile device 100 can be referred to as a “tethered” device.

The mobile devices 100a and 100b can also establish communications by other means. For example, the wireless device 100a can communicate with other wireless devices, e.g., other wireless devices 100, cell phones, etc., over the wireless network 212. Likewise, the mobile devices 100a and 100b can establish peer-to-peer communications 220, e.g., a personal area network, by use of one or more communication subsystems, such as the Bluetooth™ communication device 188 shown in FIG. 1. Other communication protocols and topologies can also be implemented.

The mobile device 100 can, for example, communicate with one or more services 230, 240, 250, 260, 270, and 280 over the one or more wired and/or wireless networks 210. For example, a navigation service 230 can provide navigation information, e.g., map information, location information, route information, and other information, to the mobile device 100. In the example shown, a user of the mobile device 100b has invoked a map functionality, e.g., by pressing the maps object 144 on the top-level graphical user interface shown in FIG. 1, and has requested and received a map for the location “1 Infinite Loop, Cupertino, Calif.”

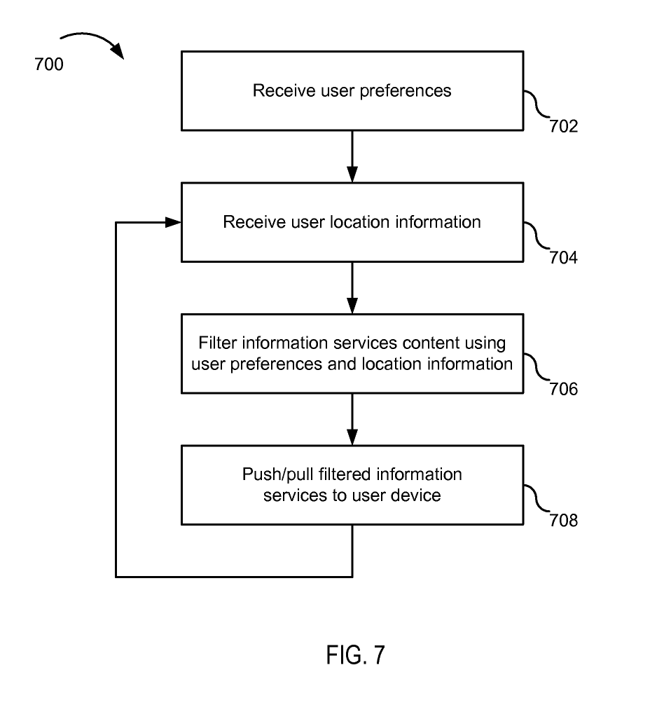

A messaging service 240 can, for example, provide e-mail and/or other messaging services. A media service 250 can, for example, provide access to media files, such as song files, movie files, video clips, and other media data. A syncing service 260 can, for example, perform syncing services (e.g., sync files). An activation service 270 can, for example, perform an activation process for activating the mobile device 100. An information service 280 can, for example, perform the process 700 for providing location-based information services, as described in reference to FIG. 7. For example, information services can provide local weather reports, local movie theater and sports venue listings, and reviews for local establishments, such as, restaurants and hotels. Such access can be provided by invocation of an information service function or application in response to a user touching the information services object 122. Other services can also be provided, including a software update service that automatically determines whether software updates exist for software on the mobile device 100, then downloads the software updates to the mobile device 100 where it can be manually or automatically unpacked and/or installed.

The mobile device 100 can also access other data and content over the one or more wired and/or wireless networks 210. For example, content publishers 270, such as news sites, RSS feeds, web sites, blogs, social networking sites, developer networks, etc., can be accessed by the mobile device 100. Such access can be provided by invocation of a web browsing function or application (e.g., a browser) in response to a user touching the Web object 114.

### Example Mobile Device Architecture

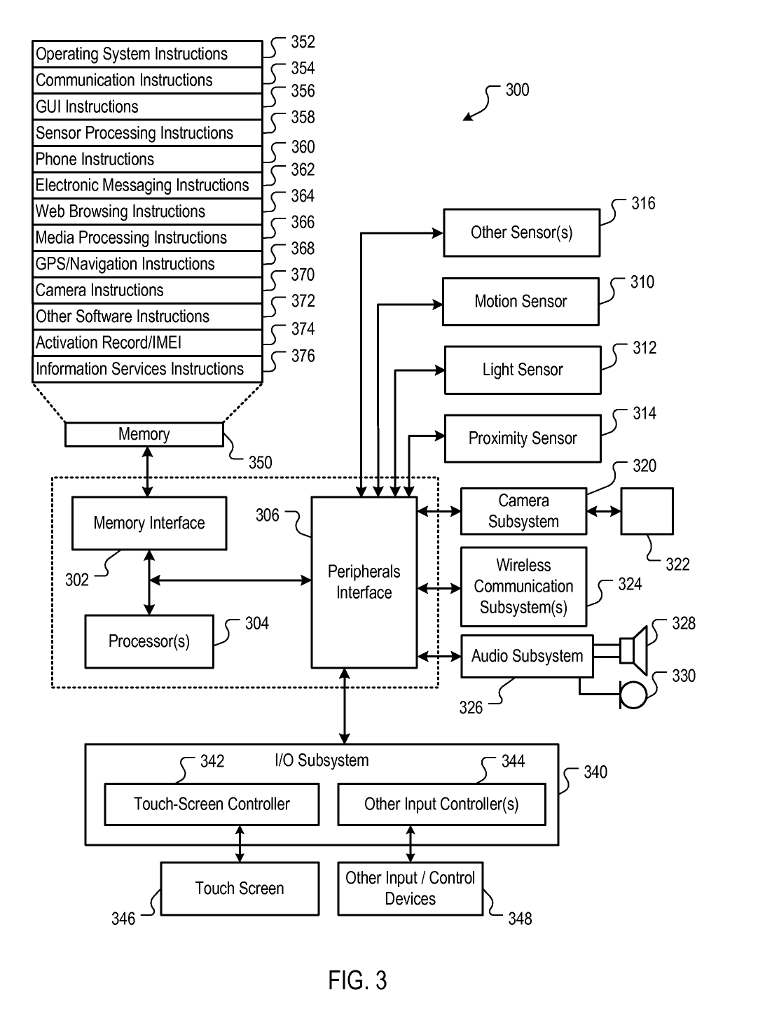

FIG. 3 is a block diagram 300 of an example implementation of the mobile device 100 of FIG. 1. The mobile device 100 can include a memory interface 302, one or more data processors, image processors and/or central processing units 304, and a peripherals interface 306. The memory interface 302, the one or more processors 304 and/or the peripherals interface 306 can be separate components or can be integrated in one or more integrated circuits. The various components in the mobile device 100 can be coupled by one or more communication buses or signal lines.

Sensors, devices, and subsystems can be coupled to the peripherals interface 306 to facilitate multiple functionalities. For example, a motion sensor 310, a light sensor 312, and a proximity sensor 314 can be coupled to the peripherals interface 306 to facilitate the orientation, lighting, and proximity functions described with respect to FIG. 1. Other sensors 316 can also be connected to the peripherals interface 306, such as a positioning system (e.g., GPS receiver), a temperature sensor, a biometric sensor, or other sensing device, to facilitate related functionalities.

A camera subsystem 320 and an optical sensor 322, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 324, which can include radio frequency receivers and transmitters and/or optical (e.g., infrared) receivers and transmitters. The specific design and implementation of the communication subsystem 324 can depend on the communication network(s) over which the mobile device 100 is intended to operate. For example, a mobile device 100 may include communication subsystems 324 designed to operate over a GSM network, a GPRS network, an EDGE network, a Wi-Fi or WiMax network, and a Bluetooth™ network. In particular, the wireless communication subsystems 324 may include hosting protocols such that the device 100 may be configured as a base station for other wireless devices.

An audio subsystem 326 can be coupled to a speaker 328 and a microphone 330 to facilitate voice-enabled functions, such as voice recognition, voice replication, digital recording, and telephony functions.

The I/O subsystem 340 can include a touch screen controller 342 and/or other input controller(s) 344. The touch-screen controller 342 can be coupled to a touch screen 346. The touch screen 346 and touch screen controller 342 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 346.

The other input controller(s) 344 can be coupled to other input/control devices 348, such as one or more buttons, rocker switches, thumb-wheel, infrared port, USB port, and/or a pointer device such as a stylus. The one or more buttons (not shown) can include an up/down button for volume control of the speaker 328 and/or the microphone 330.

In one implementation, a pressing of the button for a first duration may disengage a lock of the touch screen 346; and a pressing of the button for a second duration that is longer than the first duration may turn power to the mobile device 100 on or off. The user may be able to customize a functionality of one or more of the buttons. The touch screen 346 can, for example, also be used to implement virtual or soft buttons and/or a keypad or keyboard.

In some implementations, the mobile device 100 can present recorded audio and/or video files, such as MP3, AAC, and MPEG files. In some implementations, the mobile device 100 can include the functionality of an MP3 player, such as an iPod™. The mobile device 100 may, therefore, include a 36-pin connector that is compatible with the iPod. Other input/output and control devices can also be used.

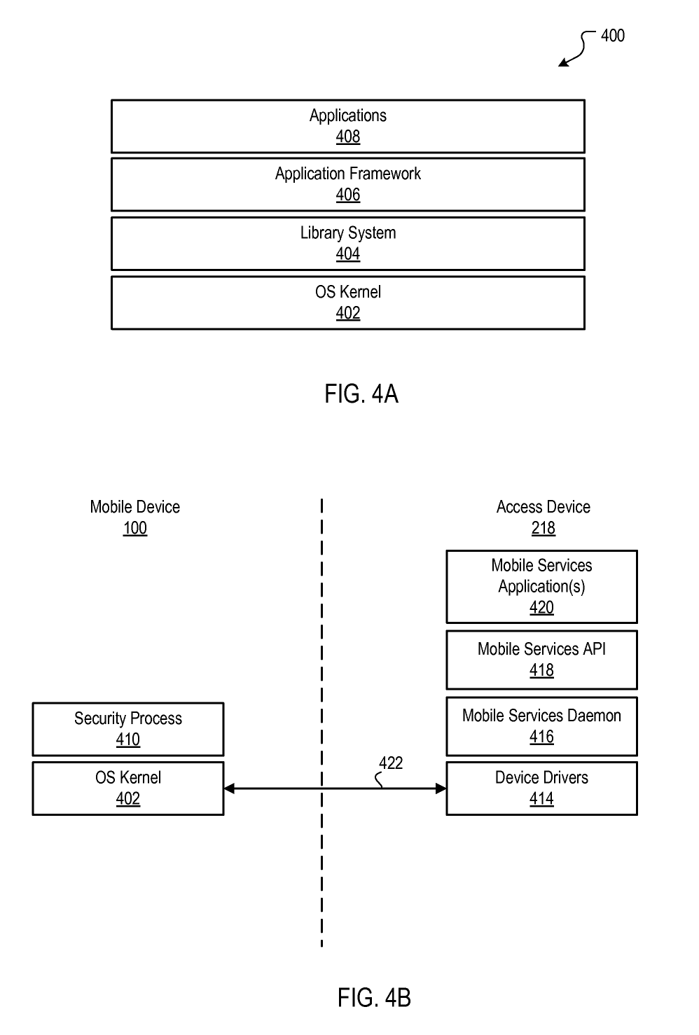

The memory interface 302 can be coupled to memory 350. The memory 350 can include high-speed random access memory and/or non-volatile memory, such as one or more magnetic disk storage devices, one or more optical storage devices, and/or flash memory (e.g., NAND, NOR). The memory 350 can store an operating system 352, such as Darwin, RTXC, LINUX, UNIX, OS X, WINDOWS, or an embedded operating system such as VxWorks. The operating system 352 may include instructions for handling basic system services and for performing hardware dependent tasks. In some implementations, the operating system 352 can be a kernel (e.g., UNIX kernel), as described in reference to FIGS. 4A and 4B.

The memory 350 may also store communication instructions 354 to facilitate communicating with one or more additional devices, one or more computers and/or one or more servers. The memory 350 may include graphical user interface instructions 356 to facilitate graphic user interface processing; sensor processing instructions 358 to facilitate sensor-related processing and functions; phone instructions 360 to facilitate phone-related processes and functions; electronic messaging instructions 362 to facilitate electronic-messaging related processes and functions; web browsing instructions 364 to facilitate web browsing-related processes and functions; media processing instructions 366 to facilitate media processing-related processes and functions; GPS/Navigation instructions 368 to facilitate GPS and navigation-related processes and instructions; camera instructions 370 to facilitate camera-related processes and functions; information services instructions 376 to facilitate information services-related processes and functions; and/or other software instructions 372 to facilitate other processes and functions, as described in reference to FIGS. 4A and 4B. An activation record and IMEI 374 or similar hardware identifier can also be stored in memory 350.

Each of the above identified instructions and applications can correspond to a set of instructions for performing one or more functions described above. These instructions need not be implemented as separate software programs, procedures, or modules. The memory 350 can include additional instructions or fewer instructions. Furthermore, various functions of the mobile device 100 may be implemented in hardware and/or in software, including in one or more signal processing and/or application specific integrated circuits.

### Software Stack and Security Process

FIG. 4A illustrates an example implementation of a software stack 400 for the mobile device of FIG. 1. In some implementations, the software stack 400 includes an operating system (OS) kernel 402 (e.g., a UNIX kernel), a library system 404, an application framework 406 and an application layer 408.

The OS kernel 402 manages the resources of the mobile device 100 and allows other programs to run and use these resources. Some examples of resources include a processor, memory, and I/O. For example, the kernel 402 can determine which running processes should be allocated to a processor, processors or processor cores, allocates memory to the processes and allocates requests from applications and remote services to perform I/O operations. In some implementations, the kernel 402 provides methods for synchronization and inter-process communications with other devices.

In some implementations, the kernel 402 can be stored in non-volatile memory of the mobile device 100. When the mobile device 100 is turned on, a boot loader starts executing the kernel 102 in supervisor mode. The kernel then initializes itself and starts one or more processes for the mobile device 100, including a security process 410 for remote access management, as described in reference to FIG. 4B.

The library system 404 provides various services applications running in the application layer 408. Such services can include audio services, video services, database services, image processing services, graphics services, etc.

The application framework 406 provides an object-oriented application environment including classes and Application Programming Interfaces (APIs) that can be used by developers to build applications using well-known programming languages (e.g., Objective-C, Java).

The applications layer 408 is where various applications exist in the software stack 400. Developers can use the APIs and environment provided by the application framework 406 to build applications, such as the applications represented by the display objects 104, 106, shown in FIG. 1 (e.g., email, media player, Web browser, phone, information services).

### Secure Communication Channel

FIG. 4B illustrates an example implementation of a security process 410 for remote access management over a secure communications channel 422. In the example shown, the mobile device 100 is running the security process 410, which communicates with the OS kernel 402. Any remote access requests made to the kernel 402 are intercepted by the security process 410, which is responsible for setting up secure communication sessions between the mobile device 100 and a mobile services access device 218. In some implementations, the process 410 uses a cryptographic protocol, such as Secure Sockets Layer (SSL) or Transport Layer Security (TLS) to provide secure communications between the mobile device 100 and the access device 218. The access device 218 can be any device with network connectivity, including but not limited to: a personal computer, a hub, an Ethernet card, another mobile device, a wireless base station, etc. The secure communications channel can be a Universal Serial Bus (USB), Ethernet, a wireless link (e.g., Wi-Fi, WiMax, 3G), an optical link, infrared link, FireWire™, or any other known communications channel or media.

In the example shown, the access device 218 includes device drivers 414, a mobile services daemon 416, a mobile services API 418 and one or more mobile services applications 420. The device drivers 414 are responsible for implementing the transport layer protocol, such as TCP/IP over USB. The mobile services daemon 416 listens (e.g., continuously) to the communications channel 422 for activity and manages the transmission of commands and data over the communication channel 422. The mobile services API 418 provides a set of functions, procedures, variables and data structures for supporting requests for services made by the mobile services application 420. The mobile services application 420 can be a client program running on the access device 218, which provides one or more user interfaces for allowing a user to interact with a remote service (e.g., activation service 270) over a network (e.g., the Internet, wireless network, peer-to-peer network, optical network, Ethernet, intranet). In some implementations, a device activation process can be used, as described in co-pending U.S. patent application Ser. No. 11/767,447, filed Jun. 22, 2007, for “Device Activation and Access,” Attorney Docket No. P5408US1/18962-113001, which patent application is incorporated by reference herein in its entirety. The application 420 can allow a user to set preferences, download or update files of content or software, search databases, store user data, select services, browse content, perform financial transactions, or engage in any other online service or function. An example of a mobile services application 420 is the iTunes™ client, which is publicly available from Apple Inc. (Cupertino, Calif.). An example of a mobile device 100 that uses the iTunes™ client is the iPod™ product developed by Apple Inc.

In an example operational mode, a user connects the mobile device 100 to the mobile access device using, for example, a USB cable. In other implementations, the mobile device 100 and access device 218 include wireless transceivers for establishing a wireless link (e.g., Wi-Fi). The drivers 414 and kernel 408 detect the connection and alert the security process 410 and mobile services daemon 416 of the connections status. Once the connection is established certain non-sensitive information can be passed from the mobile device 100 to the access device 218 (e.g., name, disk size, activation state) to assist in establishing a secure communication session.

In some implementations, the security process 410 establishes a secure communication session (e.g., encrypted SSL session) with the access device 218 by implementing a secure network protocol. For example, if using SSL protocol, the mobile device 100 and access device 218 will negotiate a cipher suite to be used during data transfer, establish and share a session key, and authenticate the access device 218 to the mobile device 100. In some implementations, if the mobile device 100 is password protected, the security process 410 will not establish a session, and optionally alert the user of the reason for failure.

Once a secure session is successfully established, the mobile device 100 and the access device 218 can exchange sensitive information (e.g., passwords, personal information), and remote access to the mobile device 100 can be granted to one or more services (e.g., navigation service 230, messaging service 240, media service 250, syncing service 260, activation service 270, information service 280). In some implementations, the mobile services daemon 416 multiplexes commands and data for transmission over the communication channel 422. This multiplexing allows several remote services to have access to the mobile device 100 in a single session without the need to start a new session (or handshaking) for each service requesting access to the mobile device 100.

### Example Information Service Block Architecture

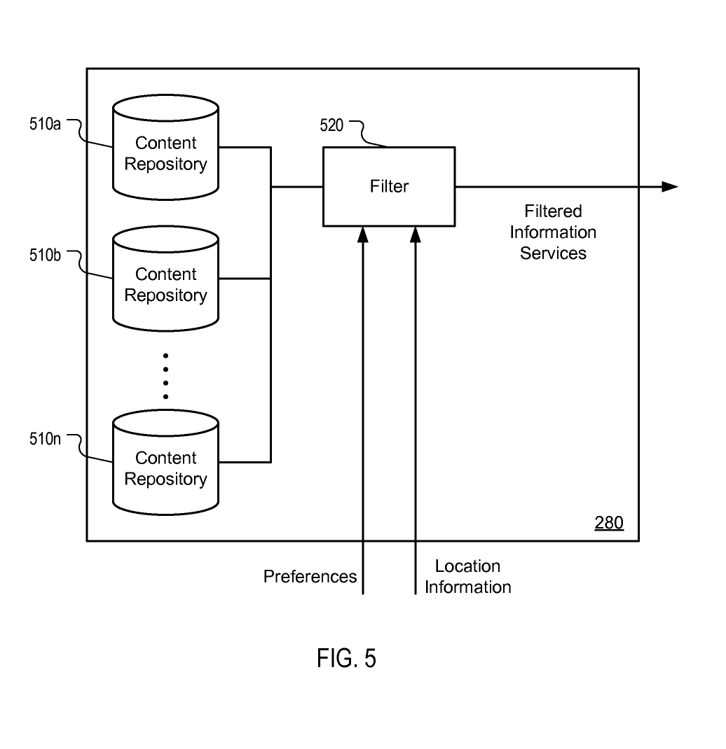

FIG. 5 is a block diagram of an example implementation of the information service block 280 of FIG. 2. The information service block 280 includes multiple content repositories 510a, . . . , 510n and a filter 520. The information service block 280 receives preferences and location information as input and generates filtered information services as output. In some implementations, the information service block 280 is a network resource which can be accessed through a network connection (e.g., the Internet, wireless network). The service block 280 can be a distributed system including a number of servers located in a number of geographic locations. The information service block 280 can include client software that resides on the mobile device and performs one or more functions of the information service block 280.

The content repositories 510 or content databases store location-based information. Some examples of location-based content items include information about points of interest (e.g., museums and zoos), venues and schedules (e.g., for sports, theater, concerts, or film), information about local bands, reviews (e.g., for restaurants, clubs, and hotels), and weather reports (e.g., snow accumulation for ski resorts). In some implementations, the location-based information can be indexed (e.g., an inverse index) in the content repositories 510 by geographic location or region, such as, for example, by metropolitan region, county, town, zip code, or telephone area code. In some implementations, the location-based information can be indexed in the content repositories 510 by the recentness of the information.

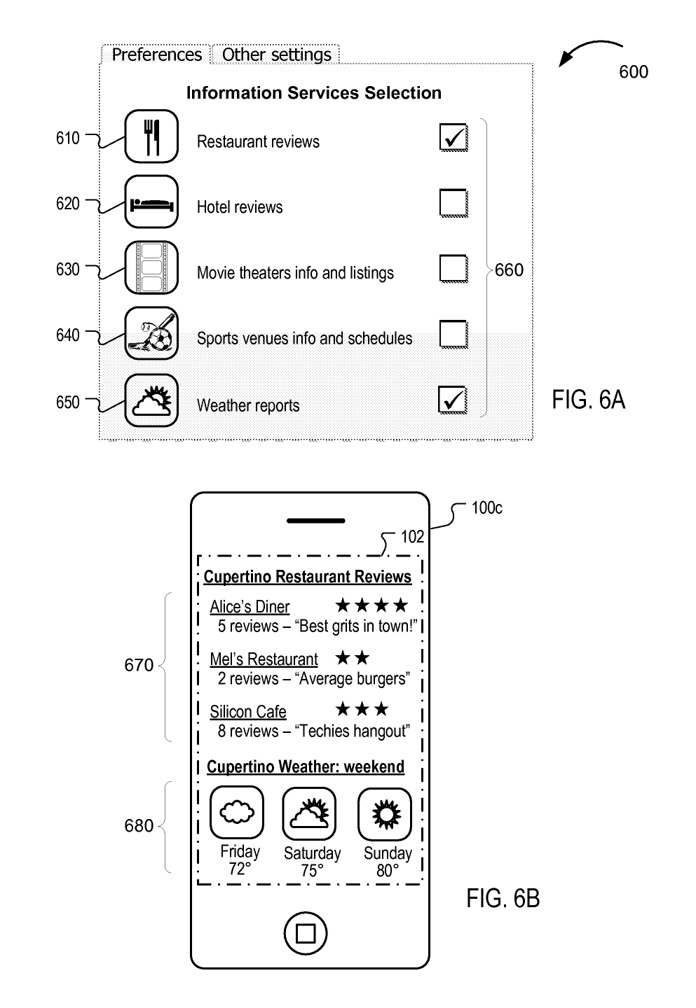

In some implementations, only one content repository 510 is included in the information service block 280. In some implementations, the information service block 280 receives location-based information from remote content repositories or servers through the wired and/or wireless networks 210. In some implementations, location-based content items stored in the local content repositories 510 are periodically updated by retrieving content from remote content repositories or servers, or from other mobile devices as described below in reference to FIG. 6. Frequently changing information can be updated more often. For example, weather reports can be updated daily, while reviews can be updated weekly. In some implementations, the local content repositories 510 receive new or updated location-based content items whenever the content items are available.

The information service block 280 can receive from the mobile device 100, through the wired and/or wireless networks 210, preferences and location information, e.g., user preferences and user geographic location information. The geographic location information can be provided by the mobile device 100 using GPS or other positioning systems (e.g., systems using Wi-Fi access points, television signals, cellular grids, or URLs). The geographic location information can be received, for example, as latitudinal and longitudinal coordinates, as a region associated with a Wi-Fi access point, or as a metropolitan region, a county, or a town. In some implementations, the mobile device 100 pushes geographic location information to the information service block 280 through the wired and/or wireless networks 210.

In some implementations, user preferences can define the types of location-based information the user of the mobile device 100 wishes to receive. For example, the user can choose to receive local weather reports but not information on local sporting events. Setting preferences for information services is described in more detail in reference to FIG. 6A and FIG. 6B. In some implementations, if the user preferences have not been set, the information service block 280 can use default settings for the mobile device 100.

The filter 520 of the information service block 280 receives as input user preferences, location information, and location-based information from the content repositories 510. In some implementations, the filter 520 also receives location-based information from content repositories or servers remote to the information service block 280. The filter 520 outputs filtered information services. That is, the filter 520 uses the received location information as a filter to prevent outputting to the mobile device 100 location-based information which is not associated with or targeted to the geographic location of the user. The location-based information services are further filtered by the preferences to include only the types of information services that the user previously selected when setting the user preferences. If the user has not set the preferences, the location-based information services can be filtered using default preferences. Thus, the “bandwidth” of the filter 520 can be “tuned” by the preferences and user's geographic location to control the amount of information pushed to or pulled by the mobile device 100.

In some implementations, the location-based information services are further filtered by user profiles. In some implementations, user profiles are stored by the mobile services application 420 of FIG. 4B, and user profile information is sent from the mobile services application 420 to the information service block 280. In other implementations, the mobile device 100 stores the user's profile, and the mobile device 100 sends the profile information to the information service block 280. A user profile is a set of information specific to a particular user. The user profile can include, for example, information about the user's known interests (e.g., preferred restaurants, favorite bands) and disinterests (e.g., disfavored film genres). As an example, if the number of location-based content items matching a user's preferences and geographic location is large, the location-based content items can be further filtered by the user's profile to return location-based information further tailored to the user's known interests, such as reviews for restaurants similar to the user's preferred restaurants, upcoming performance dates for the user's favorite bands, and film listings that do not include films of the user's disfavored genres. In some implementations, the user can enable or disable filtering based on the user's profile.

In some implementations, location-based information services for a particular user can be filtered based on the user's personal network (e.g., a network of friends, relatives, colleagues, etc.). For example, location-based information services can be filtered for a particular user by correlating the available location-based information with information which has been reviewed or provided by members of the user's network. As an example, a listing of local restaurants provided to a user can be limited to restaurants which have received reviews from the user's friends or have been visited by the user's friends. In some implementations, a user defines one or more personal networks, which can be stored as part of the user's profile. Filtering through correlation allows the location-based information services to provide targeted information that is likely to address the user's interests and needs by using additional information about the user available through the user's personal network.

In some implementations, the location-based information services are also filtered based on how the mobile device 100 receives the location-based information services from the information service block 280. For example, the location-based information may be further filtered, e.g., to return few results, if the mobile device 100 will receive the location-based information services on a wireless or wired network connection with a low data rate.

In some implementations, the location-based information services are filtered based on the time of the day, the day of the week, the season, or the holiday. For example, reviews for restaurants can be sent to the mobile device 100 in the early evening, and reviews for nightclubs can be sent to the mobile device 100 later in the evening. Traffic reports can be sent during rush hour, and listings for upcoming weekend events can be sent on Friday. In some implementations, the location-based information services are filtered based on the recentness of the information. For example, the most recent hotel reviews or the latest weather report can be pushed to or pulled by the mobile device 100.

The output of the filter 520 and the information service block 280 is filtered information services that conform to the input preferences and that are location-specific, based on the input location information. The information services can be further filtered as described above. In some implementations, the location-based information is stored on the mobile device 100, and filtering of the location-based information is performed by the mobile device 100.

### Example Preference Setting for Location-Based Information Services

FIG. 6A illustrates an example 600 of setting preferences for location-based information services for the mobile device 100 of FIG. 1. The example 600 uses a graphical user interface with a tabbed window which can be displayed in, for example, the touch-sensitive display 102 of the mobile device 100, or in a display of an access device 218 (e.g., a personal computer) when the mobile device 100 is in communication with the access device 218. For example, a mobile services application 420 of the access device 218 can allow a user to set preferences for the location-based information services.

The example 600 for selecting information services includes types of location-based information services 610, 620, 630, 640, and 650 and corresponding checkboxes 660. In this example, a user of the mobile device 100 can choose to receive location-based restaurant reviews 610, hotel reviews 620, movie theaters information and listings 630, sports venues information and schedules 640, and weather reports 650. The user can select the types of location-based services the user wishes to receive by checking the corresponding checkbox 660 for the desired service. In some implementations, the default setting for the location-based services is “on” and the user can deactivate a service by un-checking the corresponding checkbox for the undesired service. In some implementations, more service types are available than can be presented in a display, and the graphical user interface includes one or more scrollbars or arrow keys to display additional service types in the same window or on additional pages, respectively. In the example 600, the user has set the preferences for the location-based information services by choosing to receive only the restaurant reviews 610 and the weather reports 650. In some implementations, one or more of the categories shown in FIG. 6 can have subcategories that can be selected to further refine the information to be provided to the mobile device. The subcategories can be accessed through menus or other control structures.

In some implementations, the user sets the preferences at the time the mobile device 100 is configured or activated. The user can modify the preference settings at a later date. In some implementations, the first time a user requests location-based information services (e.g., by selecting the information services object 122 of FIG. 1), the user is presented with the information services selection interface, such as the tabbed window in example 600. In some implementations, the location-based preferences are themselves location based. That is, a preference set can be associated with a particular location (e.g., home preferences, work preferences, out of home state preferences, etc.).

### Example Location-Based Information Services Functionality

FIG. 6B illustrates an example of using the mobile device 100 of FIG. 1 to receive and display location-based information services. The location-based information services can be presented to a user on a mobile device 100 in response to the user touching the information services object 122 of FIG. 1. In some implementations, presentation of the location-based information services is triggered by other events, such as receipt of user action invoking navigation service 230 of FIG. 2.

The touch-sensitive display 102 of the mobile device 100c displays information services which have been filtered according to the user's location information and the user's preferences, as described in reference to FIG. 5. In the example shown, the user's location information (i.e., the geographic location of the user's mobile device) is associated with Cupertino, Calif. Thus, the information services is filtered to provide only information associated with Cupertino, Calif. Based on the selection of restaurant reviews 610 and weather reports 650 in the user preference setting in example 600 of FIG. 6A, the location-based information services is further filtered to display only restaurant reviews 670 and weather reports 680 for the user location, i.e., Cupertino, Calif.

In some implementations, the location-based information services appear in the touch-sensitive display 102 of the mobile device 100c as selectable display objects. For example, if the user selects multiple information services when setting preferences, the touch-sensitive display 102 can display an icon for each selected service. When the user selects one of the displayed information service icons, the user can be presented with different information within the selected information service type. As an example, local hour-by-hour, weekend, and 10-day forecasts can be presented to a user when the user selects a weather report icon.

In some implementations, the user can provide location-based information to a network-based repository and/or service, e.g., by providing information (e.g., feedback) to augment information the user received from a location-based service. The user-provided location-based information can be used to enrich information that can be provided to other users. For example, upon viewing one of the reviews 670 for a local restaurant in the display of the mobile device 100c, a user can provide a new review for the local restaurant in the location-based service, e.g., by entering the review in the mobile device 100c, where the new review is pushed by the mobile device 100c to a network-based repository or service using the wired and/or wireless networks 210. Other types of location-based information can be provided by the user. For example, the user can upload photos of the local restaurant to be displayed with the restaurant's reviews.

In some implementations, if a particular user provides location-based information, this information can be used to enrich or further refine other location-based information sent to the particular user. For example, if a user provides location-based information indicating (e.g., through a positive review or other feedback) that the user likes a particular restaurant, reviews or listings of other restaurants similar to the particular restaurant can be provided to the user. In another example, if a first user provides feedback indicating that the first user likes a particular hotel and other users of the location-based information services have also given high ratings for that hotel, the first user can receive reviews or listings of other hotels which were also highly rated by the other users. This correlation allows location-based information services to be targeted to a user based on information known about other users with similar taste or preferences. In some implementations, this information is available through the user profiles of the other users.

### Example Location-Based Information Services Process

FIG. 7 is a flow diagram of an example process 700 for providing location-based information services for the mobile device of FIG. 1. The process 700 begins by receiving user preferences for the information services (702). The information service block 280 can receive user preferences when the user initially sets or updates the user preferences for the information services. If the user has not set preferences for the information services, default user preferences can be received.

The information service block 280 receives user location information (704). In some implementations, user preferences are received each time user location information is received. The user location information can be received as, for example, GPS latitudinal and longitudinal coordinates. In some implementations, the information service block 280 receives user location information whenever the positioning system detects a change in the user location and the change exceeds a certain threshold. For example, location information may be sent only when the positioning system detects a change in the user's longitude or latitude that exceeds x degrees or that places the user in a new neighborhood, city, county, state, etc. In some implementations, receipt of user location information can be triggered each time the user invokes the navigation service 230 of FIG. 2. In some implementations, receipt of user location information can be triggered by a time of day.

Information services content is filtered using the user preferences and the user location information (706). The information services content can be stored in the mobile device 100, or in content repositories or servers local or remote to the information service block 280. In some implementations, the information services content is filtered using other information or settings. For example, information in the user's profile or information in the profiles of other users can be received and used to filter the information services content.

The filtered information services are pushed to or pulled from the user mobile device 100 (708). In some implementations, the filtered services are provided to the user through the wired and/or wireless networks 210. In some implementations, the filtered services are pushed or pulled automatically, e.g., at scheduled intervals. Alternatively or in addition, the pushing or pulling of filtered services can be triggered by user actions, e.g., the user touching the information services object 122 of FIG. 1.

The process 700 can repeat when new user location information is received (704). Alternatively, the process 700 can repeat when modified user preferences are received (702). In some implementations, updates of the user location information to the information service block 280 or updates of the filtered information to the mobile device 100 are triggered by certain events. One triggering event is the availability of updated location-based information, including user-provided information (e.g., new restaurant reviews). For example, if the user subscribes to weather reports (e.g., by selecting weather reports in the user's preference settings), receipt by the information service block 280 of a weather report indicating a drastic change in the weather can trigger the updated weather report to be sent to the mobile device 100 of the user. In some implementations, the updates occur periodically, e.g., on a predetermined schedule.

In some implementations, the user has the option to turn off updates of the user location information to the information services or the option to turn off updates of the filtered information to the mobile device 100. For example, the interface for the preference settings can include a checkbox to activate or deactivate location updating to the location-based information services. The user may wish to turn off location updates, for example, if the user is traveling but wishes to view location-based information associated with the user's home location.

In some implementations, the user has the option to manually provide location information. This can be an option available for selection in the preferences setting graphical user interface. The user may wish to manually provide location information, for example, if the user will soon travel to a new location and wishes to view location-based information associated with the new location in advance of actually arriving at the new location. In some implementations, a user can manually provide the location information, e.g., as an address or as position coordinates. For example, the user can enter position coordinates by typing on a virtual keyboard of the mobile device 100 or by selecting a point on a map displayed by a map application of the mobile device 100.

In some implementations, the user has the option to receive location-based information services for more than one geographic location at a time. In one example, if the user is traveling, the user can receive location-based content items for both the user's present location and the user's home location. In some implementations, a user can manually provide location information for each location for which the user wishes to receive location-based information services.

The features described can be implemented in digital electronic circuitry, or in computer hardware, firmware, software, or in combinations of them. The features can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

A number of implementations have been described. Nevertheless, it will be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
receiving first information associated with a user of a mobile device;
receiving second information identifying a first geographic location of the mobile device;
filtering location-based content using the first information and the second information; and
providing the filtered location-based content to the user at the mobile device, where the mobile device includes a multi-touch-sensitive display.

2. The method of claim 1, further comprising:
receiving third information identifying a second geographic location of the mobile device; and
providing updated filtered location-based content to the user, the updated filtered location-based content being location-based content filtered using the third information.

3. The method of claim 1, further comprising:
receiving third information provided by the user of the mobile device; and
adding the third information to the location-based content.

4. The method of claim 1, where the first information associated with the user identifies a selection of one or more types of location-based content.

5. The method of claim 4, where receiving the first information further comprises:
presenting a graphical user interface requesting information; and
receiving input responsive to the request.

6. The method of claim 4, where the selection of one or more types of location-based content is location-based.

7. The method of claim 1, where the second information identifying the first geographic location of the mobile device is provided by the mobile device.

8. The method of claim 1, where the location-based content is filtered by the mobile device.

9. The method of claim 1, where the mobile device includes a telephony application.

10. The method of claim 1, where filtering location-based content further comprises filtering location-based content using information from at least one user profile.

11. The method of claim 1, where filtering location-based content further comprises filtering location-based content based on time.

12. A method comprising:
receiving first information associated with a user of a mobile device;
receiving second information identifying a first geographic location of the mobile device;
receiving third information associated with a user profile of a different user;
filtering location-based content using the first information, the second information, and the third information; and
providing the filtered location-based content to the user at the mobile device.

13. A method comprising:
receiving first information associated with a user of a mobile device;
receiving second information identifying a first geographic location of the mobile device;
filtering location-based content using the first information and the second information, where the location-based content is filtered at the mobile device; and
providing the filtered location-based content to the user at the mobile device.

14. A system comprising:
a processor;
a computer-readable medium coupled to the processor and including instructions, which, when executed by the processor, causes the processor to perform operations comprising:
receiving first information associated with a user of a mobile device;
receiving second information identifying a first geographic location of the mobile device;
filtering location-based content using the first information and the second information; and
providing the filtered location-based content to the user at the mobile device, where the mobile device includes a multi-touch-sensitive display.

15. The system of claim 14, where the processor performs operations comprising:
receiving third information identifying a second geographic location of the mobile device; and
providing updated filtered location-based content to the user, the updated filtered location-based content being location-based content filtered using the third information.

16. The system of claim 14, where the processor performs operations comprising:
receiving third information provided by the user of the mobile device; and
adding the third information to the location-based content.

17. The system of claim 14, where the first information associated with the user identifies a selection of one or more types of location-based content.

18. The system of claim 17, where receiving the first information further comprises:
presenting a graphical user interface requesting information; and
receiving input responsive to the request.

19. The system of claim 17, where the selection of one or more types of location-based content is location-based.

20. The system of claim 14, where the second information identifying the first geographic location of the mobile device is provided by the mobile device.

21. The system of claim 14, where the location-based content is filtered by the mobile device.

22. The system of claim 14, where the mobile device includes a telephony application.

23. The system of claim 14, where filtering location-based content further comprises filtering location-based content using information from at least one user profile.

24. The system of claim 14, where filtering location-based content further comprises filtering location-based content based on time.

25. A computer-readable medium having instructions stored thereon, which, when executed by a processor, causes the processor to perform operations comprising:
receiving first information associated with a user of a mobile device;
receiving second information identifying a first geographic location of the mobile device;
filtering location-based content using the first information and the second information; and
providing the filtered location-based content to the user at the mobile device, where the mobile device includes a multi-touch-sensitive display.
